(19) United States
(12) Patent Application Publication
(10) Pub. No.: US 2021/0344577 A1
(43) Pub. Date: Nov. 4, 2021

(54) DETERMINATION DEVICE, GATEWAY, DETERMINATION METHOD, AND DETERMINATION PROGRAM

(71) Applicant: Nippon Telegraph and Telephone Corporation, Tokyo (JP)

(72) Inventors: Hideo Tsuchiya, Musashino-shi, Tokyo (JP); Akihiro Okada, Musashino-shi, Tokyo (JP); Katsuma Miyamoto, Musashino-shi, Tokyo (JP)

(21) Appl. No.: 17/268,788

(22) PCT Filed: Aug. 12, 2019
(86) PCT No.: PCT/JP2019/032711

§ 371 Date: Feb. 16, 2021

(30) Foreign Application Priority Data
Aug. 22, 2018 (JP) 2018-155841

(51) Int. Cl. H04L 12/26; H04L 12/66

(52) U.S. Cl. CPC H04L 43/062; H04L 12/66; H04L 43/04; H04L 43/0817

(57) ABSTRACT

A collection unit (22) collects traffic information generated when data is transmitted from an IoT device connected to the network. When the traffic information collected by the collection unit (22) satisfies the determination condition preset based on a traffic pattern of each IoT device, a determination unit (23) determines that an abnormality occurs in the IoT device that generates the traffic.

### TECHNICAL FIELD

The present disclosure relates to a determination apparatus, a gateway, a determination method, and a determination program.

### BACKGROUND ART

Heretofore, failures of Internet of things (IoT) devices have been determined by a script for alive monitoring, state monitoring by an alarm from each device, and execution of a command to confirm the normality of operation (see, for example, Non Patent Literatures 1 and 2).

### CITATION LIST

### Non Patent Literature

Non Patent Literature 1: Nihon Unisys, “IoT Device Management Function”, [online], [Searched on Aug. 3, 2018], Internet (https://www.unisys.co.jp/solution/tec/iot/bp/bp02.html) Non Patent Literature 2: Hitachi Solutions, “Introduction of IoT/M2M Data Collection, Analysis and Utilization Infrastructure”, [online], [Searched on Aug. 3, 2018]; Internet (https://www.hitachi-solutions.co.jp/reports/dms2016/pdf/presentation06.pdf)

### SUMMARY OF THE INVENTION

### Technical Problem

However, related-art failure determination techniques are problematic in that procedures are complex and may require extra communication costs.

For example, a method of executing a command to confirm the normality of operation requires preparation of a command matching the operation of each device, which makes it complicated to deal with. In addition, even in the case of using any of script, alarm, and command to determine a failure as described above, for analysis of data, data communication costs occur between the device and a management cloud or the like. Examples of the communication costs include processing loads in a carrier network and communication charges of the user.

### Means for Solving the Problem

In order to solve the problems described above and attain an object, a determination apparatus includes a collection unit that collects information of traffic generated when data is transmitted from a device connected to a network, and a determination unit that determines that an abnormality occurs in the device that generated the traffic when the information of the traffic collected by the collection unit satisfies a determination condition preset based on a traffic pattern of each of a plurality of the devices.

### Effects of the Invention

According to the present disclosure, a failure of an IoT device can be easily determined at low costs.

### BRIEF DESCRIPTION OF DRAWINGS

FIG. 1 is a diagram illustrating an example of determination processing according to a first embodiment.

FIG. 2 is a diagram illustrating an example of the determination processing according to the first embodiment.

FIG. 3 is a diagram illustrating a determination pattern according to the first embodiment.

FIG. 4 is a diagram illustrating the determination pattern according to the first embodiment.

FIG. 5 is a diagram illustrating the determination pattern according to the first embodiment.

FIG. 6 is a diagram illustrating the determination pattern according to the first embodiment.

FIG. 7 is a diagram illustrating an example of a configuration of a virtual CPE according to the first embodiment.

FIG. 8 is a diagram illustrating an example of a configuration of an IoT gateway according to the first embodiment.

FIG. 9 is a diagram illustrating an example of information stored in the virtual CPE according to the first embodiment.

FIG. 10 is a diagram illustrating an example of information stored in an IoT gateway according to the first embodiment.

FIG. 11 is a sequence diagram illustrating a processing sequence of a determination system according to the first embodiment.

FIG. 12 is a diagram illustrating an example of a computer that executes a determination program.

### DESCRIPTION OF EMBODIMENTS

Hereinafter, an embodiment of a determination apparatus, a gateway, a determination method, and a determination program according to the present application will be described in detail with reference to the drawings. Note that the present disclosure is not limited to the embodiments described below. Note that the virtual CPE in the embodiment is an example of a determination apparatus.

### First Embodiment

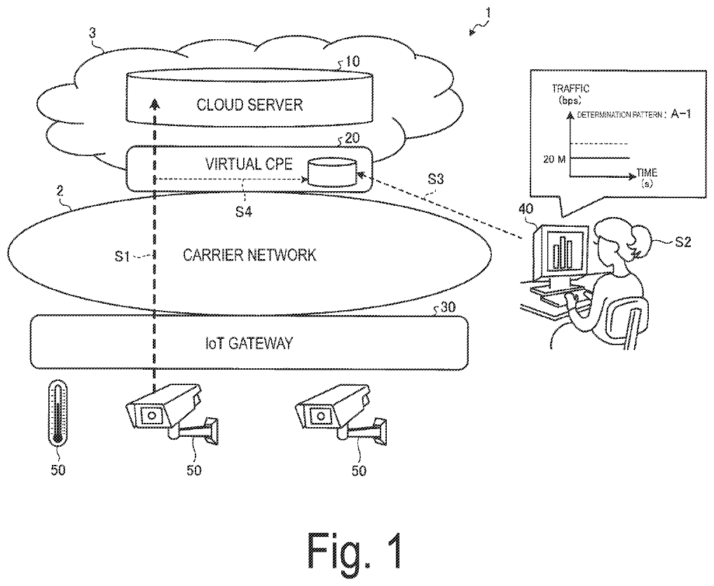

First, a determination processing performed by a determination system having a determination apparatus will be described with reference to FIG. 1. FIG. 1 is a diagram illustrating an example of the determination processing according to the first embodiment. As illustrated in FIG. 1, a determination system 1 includes a cloud server 10, a virtual customer premises equipment (CPE) 20, an IoT gateway 30, an operator terminal 40, and an IoT device 50,

The cloud server 10 is provided in a cloud network 3. The virtual CPE 20 is provided between the cloud network 3 and a carrier network 2. The IoT gateway 30 is connected to the carrier network 2. The operator terminal 40 is a terminal operated by an operator of the determination system 1. The operator terminal 40 can transmit and receive data to and from the virtual CPE 20.

The IoT device 50 is accommodated in the IoT gateway 30. Examples of the IoT device 50 include a security camera, an automobile, a drone, a home appliance, and various sensors. The IoT device 50 transmits predetermined data to the cloud server 10 according to a traffic pattern. Examples of the traffic pattern include continuous communication, periodic communication, and occasional (random) communication.

When the IoT device 50 continuously transmits data, the traffic pattern is continuous communication. When the IoT device 50 transmits data at a predetermined time period (e.g., once per minute), the traffic pattern is periodic communication. When the IoT device 50 transmits data at a timing at which prescribed processing is performed or at a random timing, the traffic pattern is occasional communication.

Here, determination processing will he described. First, as illustrated in FIG. 1, the IoT device 50, when installed, transmits data to the cloud server 10 via the IoT gateway 30, the carrier network 2, and the virtual CPE 20 (Step S1).

Here, when the IoT device 50 is configured, the operator terminal 40 inputs information regarding the IoT device 50 to the virtual CPE 20 by an operator's operation (Step S2). Then, the operator terminal 40 sets, with respect to the virtual CPE 20, a determination condition based on the determination pattern by an operator's operation (Step S3). The virtual CPE 20 may automatically generate and set the determination condition. In addition, the virtual CPE 20 starts collecting information of traffic generated when data is transmitted from the IoT device 50 to the cloud server 10 (Step S4).

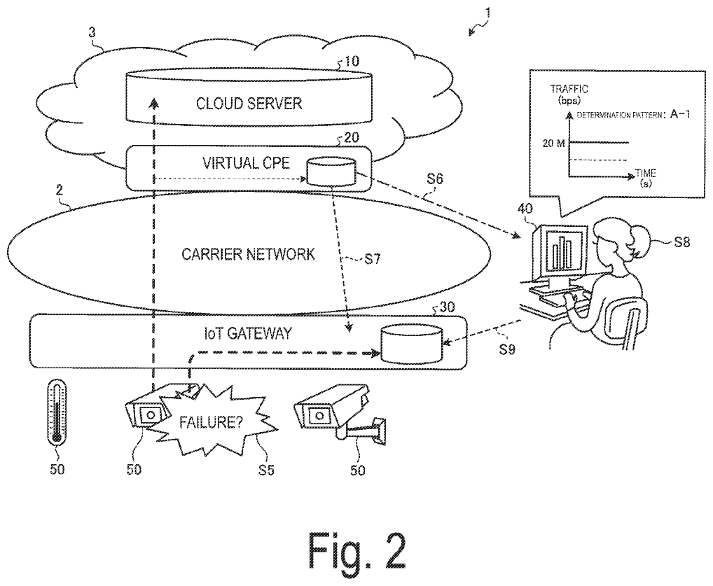

With reference to FIG. 2, in the determination processing, processing following Step S4 will be described. FIG. 2 is a diagram illustrating an example of the determination processing according to the first embodiment. As illustrated in FIG. 2, it is assumed that a failure occurs in the IoT device 50 and an abnormality occurs in the traffic generated by data transmission from the IoT device 50 (Step S5).

At this time, the virtual CPE 20 determines that an abnormality occurs in the IoT device 50 based on the collected traffic information. Then, the virtual CPE 20 transmits an alarm to the operator terminal 40 (Step S6). Further, the virtual CPE 20 instructs the IoT gateway 30 accommodating the IoT device 50 to stop transferring data transmitted from the IoT device 50 and accumulate the data (Step S7).

In addition, the operator can confirm the traffic information using the operator terminal 40, manually determine the presence or absence of an abnormality, and consider responses such as replacement of the device (Step SS). The operator terminal 40 can refer to data accumulated in the IoT gateway 30 in response to an instruction from the virtual CPE 20 (Step S9).

### Determination Conditions

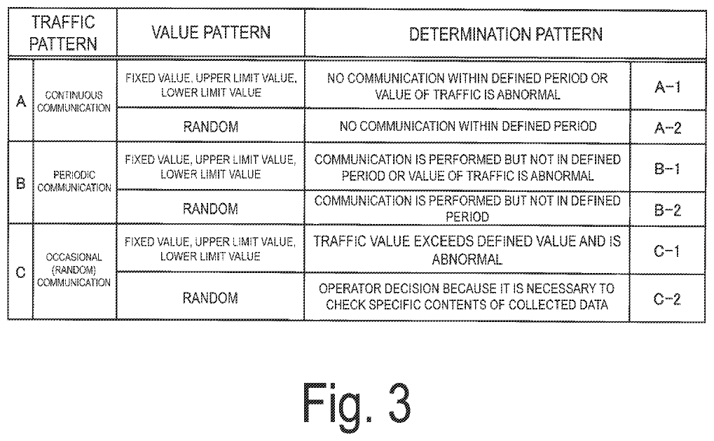

A determination pattern will be described below using FIGS. 3 to 6. FIGS. 3 to 6 are diagrams for explaining the determination pattern according to the first embodiment. The determination pattern is identified based on a traffic pattern and a value pattern.

As illustrated in FIG. 3, the traffic pattern in the present embodiment includes continuous communication, periodic communication, and occasional (random) communication. The traffic pattern may also be determined based on the characteristics of the device-by-device operation. For example, the traffic pattern of a security camera that continuously transmits taken image data is the continuous communication. For example, the traffic pattern of a temperature sensor that transmits temperature measured every minute is the periodic communication. For example, the traffic pattern of consumer appliance that transmits data only when the switch is turned on or off is the occasional communication.

The value pattern in the present embodiment includes a fixed value, an upper limit value, a lower limit value, and a random. The value pattern is determined based on the amount of data transmitted by the IoT device 50 during normal operation. For example, the value pattern of the security camera is determined based on file size of image data transmitted when the security camera is normally operating.

For example, when the file size of the image data transmitted by the security camera during normal operation is constant at all times, the value pattern of the security camera is the fixed value. For example, when the security camera has an upper limit or a lower limit to the file size of the image data transmitted during normal operation, the value pattern of the security camera is the upper limit value or the lower limit value. For example, when the file size of the image data transmitted during normal operation of the security camera is not constant, and has neither upper limit nor lower limit, the value pattern of the security camera is random.

As illustrated in FIG. 3, in the present embodiment, determination patterns of A-1, A-2, B-1, B-2, C-1, and C-2 are determined by the combination of the traffic pattern and the value pattern.

Using FIG. 4, the determination pattern A-x for the continuous communication (where x is a number identifying each determination pattern) will be described. As illustrated in FIG. 4, the determination pattern A-1 is assigned when the traffic pattern is the continuous communication and the value pattern is one of the fixed value, the upper limit value, and the lower limit value. The determination system 1 determines, for the IoT device 50 for which the determination pattern A-1 is assigned, that there is an abnormality when there is no communication within a defined period or the value of the traffic is abnormal.

The determination pattern A-2 is assigned when the traffic pattern is the continuous communication and the value pattern is random. The determination system 1 determines, for the IoT device 50 for which the determination pattern A-2 is assigned, that there is an abnormality when there is no communication within the defined period.

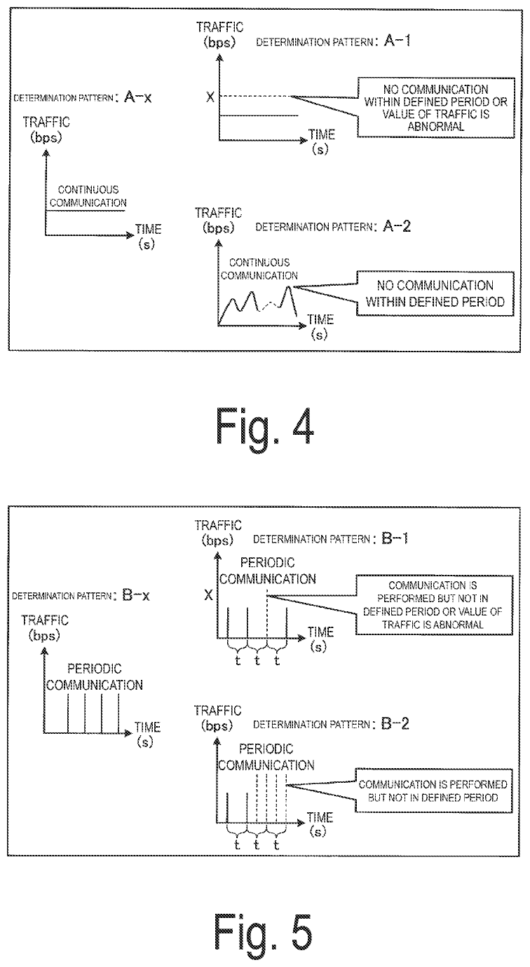

Using FIG. 5, a determination pattern B-x for the periodic communication (where x is a number identifying each determination pattern) will be described. As illustrated in FIG. 5, the determination pattern B-1 is assigned when the traffic pattern is the periodic communication and the value pattern is one of the fixed value, the upper limit value, and the lower limit value. The determination system 1 determines, for the IoT device 50 for which the determination pattern B-1 is assigned, that there is an abnormality when there is communication but not in the defined period or the value of the traffic is abnormal.

The determination pattern B-2 is assigned when the traffic pattern is the periodic communication and the value pattern is random. The determination system 1 determines, for the IoT device 50 for which the determination pattern B-2 is assigned, that there is an abnormality when there is communication but not in the defined period.

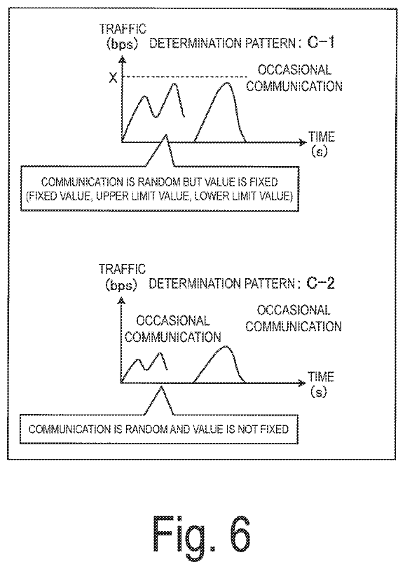

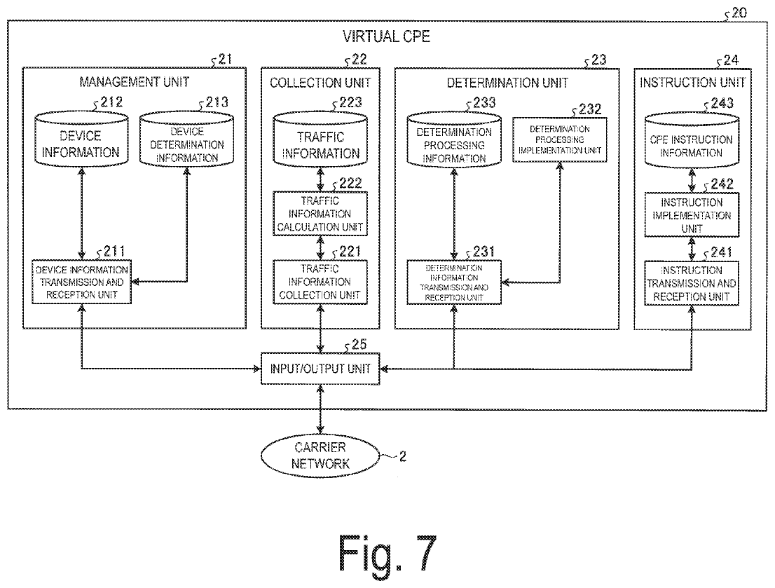

As illustrated in FIG. 6, the determination pattern C-1 is assigned when the traffic pattern is the occasional communication and the value pattern is one of the fixed value, the upper limit value, and the lower limit value. The determination system 1 determines that there is an abnormality for the IoT device 50 in which the determination pattern C-1 is assigned, when communication is random but the value is fixed (e.g., the lower limit value or less at all times).

The determination pattern C-2 is assigned when the traffic pattern is the occasional communication and the value pattern is random. In this case, the determination system 1 can transmit, to the operator terminal 40, a message indicating that the abnormality determination is entrusted to the operator.

### Configuration of First Embodiment

Using FIG. 7, a configuration of the virtual CPE 20 will be described. FIG. 7 is a diagram illustrating an example of the configuration of a virtual CPE according to the first embodiment. As illustrated in FIG. 7, the virtual CPE 20 includes a management unit 21, a collection unit 22, a determination unit 23, an instruction unit 24, and an input/output unit 25. The input/output unit 25 inputs and outputs data via the carrier network 2 and the like.

The management unit 21 manages information regarding the IoT device 50. The management unit 21 includes a device information transmission and reception unit 211, device determination information 213, and device information 212. The device information transmission and reception unit 211 transmits and receives the device information 212 and the device determination information 213.

For example, the device information 212 is information regarding the IoT device 50 input from the operator terminal 40 in Step S2 in FIG. 1. For example, the device determination information 213 is the determination condition set from the operator terminal 40 in Step S3 in FIG. 1.

The collection unit 22 collects traffic information generated when data is transmitted from the IoT device 50 connected to the network. The collection unit 22 includes a traffic information collection unit 221, a traffic information calculation unit 222, and traffic information 223. The traffic information collection unit 221 receives an input of data indicating traffic information. The traffic information calculation unit 222 calculates predetermined calculation based on the input data, and acquires the traffic information 223.

When the traffic information collected by the collection unit 22 satisfies the determination condition preset based on the traffic pattern of each of the JOT devices 50, the determination unit 23 determines that there is an abnormality in the IoT device 50 that generates the traffic.

The determination unit 23 includes a determination information transmission and reception unit 231, a determination processing implementation unit 232, and determination processing information 233. The determination information transmission and reception unit 231 transmits and receives the determination condition, the traffic information to be determined, and determination results. The determination processing information 233 is the traffic information to be determined. The determination processing implementation unit 232 uses the determination condition and the traffic information to be determined to implement actual determination.

When the determination unit 23 determines that an abnormality occurs in the IoT device 50, the instruction unit 24 instructs the IoT gateway 30 accommodating the IoT device 50 to accumulate data to be transmitted from the IoT device 50. The instruction unit 24 includes an instruction transmission and reception unit 241, an instruction implementation unit 242, and CPE instruction information 243. The instruction transmission and reception unit 241 transmits and receives instructions. The instruction implementation unit 242 generates an instruction based on the determination result from the determination unit 23 and passes the instruction to the instruction transmission and reception unit 241. The CPE instruction information 243 is information regarding the IoT gateway 30 and the IoT device 50 to which the instruction is directed.

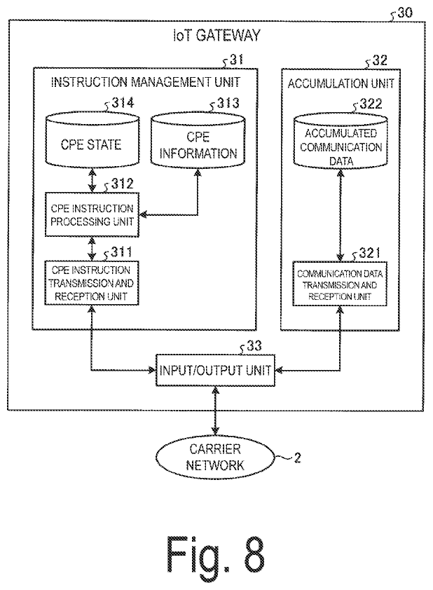

Using FIG. 8, a configuration of the IoT gateway 30 will be described. FIG. 8 is a diagram illustrating an example of a configuration of the IoT gateway according to the first embodiment. As illustrated in FIG. 8, the IoT gateway 30 includes an instruction management unit 31, an accumulation unit 32, and an input/output unit 33. The input/output unit 25 inputs and outputs data via the carrier network 2 and the like.

The instruction management unit 31 manages instructions received from the virtual CPE 20. The instruction management unit 31 includes a CPE instruction transmission and reception unit 311, a CPE instruction processing unit 312, CPE information 313, and a CPE state 314.

The CPE instruction transmission and reception unit 311 receives an instruction from the virtual CPE 20. The CPE instruction processing unit 312 executes the received instruction. In other words, in response to the instruction from the instruction unit 24, the CPE instruction processing unit 312 controls the IoT gateway 30 to stop transferring data transmitted from the specified IoT 50 and accumulate the data. The CPE information 313 is information regarding the IoT device 50 accommodated in the IoT gateway 30. The CPE state 314 is information indicating whether the data accumulation is being performed, and the amount of accumulated data, for each IoT devices 50.

The accumulation unit 32 includes a communication data transmission and reception unit 321 and accumulated communication data 322. The communication data transmission and reception unit 321 receives data transmitted by the IoT device 50 and stores the data as the accumulated communication data 322.

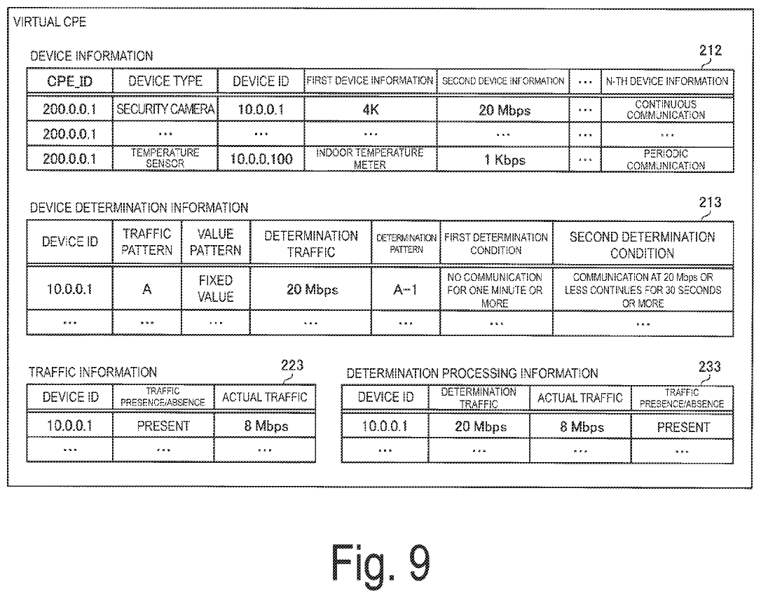

Using FIG. 9, information stored in the virtual CPE 20 will be described. FIG. 9 is a diagram illustrating an example of the information stored in the virtual CPE according to the first embodiment. As illustrated in FIG. 9, the virtual CPE 20 stores the device information 212, the device determination information 213, the traffic information 223, and the determination processing information 233.

The device information 212 includes CPE_ID, device type, device ID, first to N-th device information. The CPE_ID is information identifying the IoT gateway 30 accommodating the IoT device 50. The device type is a type of IoT device 50. The device ID is information identifying the IoT device 50. The first to N-th device information is specific information regarding the IoT device 50. The first to N-th device information may include the traffic pattern and the value pattern. Note that the CPE ID and the device ID each may be an IP address.

In the example of FIG. 9, the device information 212 indicates that information such as “4K”, “200 Mbps”, and “continuous communication” is set to a security camera having the device ID “10.0.0.1.” accommodated in the IoT gateway 30 having the CPE_ID “200.0.0.1”.

The device determination information 213 includes the device ID, the traffic pattern, the value pattern, determination traffic, the determination pattern, a first determination condition, and a second determination condition. When the traffic information collected by the collection unit 22 satisfies the determination condition that is the combination of the determination pattern identified for each traffic pattern of each IoT device 50 and the traffic amount expected for each IoT device 50, the determination unit 23 determines that an abnormality occurs in the IoT device 50 that generates the traffic. At this time, an example of the traffic amount expected for each device 50 is the determination traffic in the device determination information 213.

In the example of FIG. 9, the device determination information 213 indicates that the IoT device 50 having the device ID “10.0.0.1” has the traffic pattern “A”, the value pattern “fixed value”, the determination traffic “20 Mbps”, the determination pattern “A-1”, the first determination condition “no communication for one minute or more”, and the second determination condition “communication at 20 Mbps or less continues for 30 seconds or more”. In this case, the second determination condition is a determination condition that is a combination of the determination pattern and the determination traffic.

Also, as illustrated in FIG. 9, the traffic information 223 includes device ID, traffic presence/absence, and actual traffic. The actual traffic is the traffic collected by the collection unit 22. In the example of FIG. 9, the traffic information 223 indicates that the IoT device 50 having the device ID “10.0.0.1” has traffic presence/absence “present”, and the actual traffic “8 Mbps”.

As illustrated in FIG. 9, the determination processing information 233 includes device ID, determination traffic, actual traffic, and traffic presence/absence. In the example of FIG. 9, the determination processing information 233 indicates that the IoT device 50 having the device ID “10.0.0.1” has the determination traffic “20 Mbps”, the actual traffic “8 Mbps”, and the traffic presence/absence “present”.

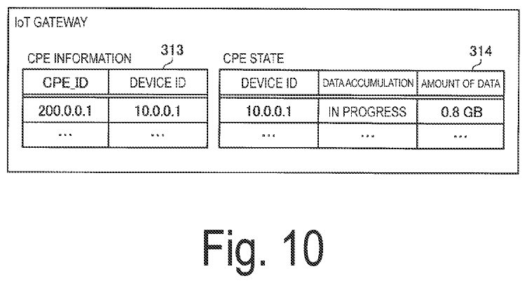

Using FIG. 10, information stored in the IoT gateway 30 will be described. FIG. 10 is a diagram illustrating an example of the information stored in the IoT gateway according to the first embodiment. As illustrated in FIG. 10, the IoT gateway 30 stores the CPE information 313 and the CPE state 314.

In the example of FIG. 10, the CPE information 313 indicates that the IoT gateway 30 having the CPE ID “200.0.0.1” accommodates the IoT device 50 having the device ID “10.0.0.1”. Note that the CPE information 313 may include only information regarding the IoT device 50 (fault-suspected device) determined to have an abnormality.

Also, in the example of FIG. 10, the CPE state 314 indicates that the instruction to accumulate the data of the IoT device 50 having the device ID “10.0.0.1” is in progress, and “0.8 GB” of data has been accumulated.

### Processing of First Embodiment

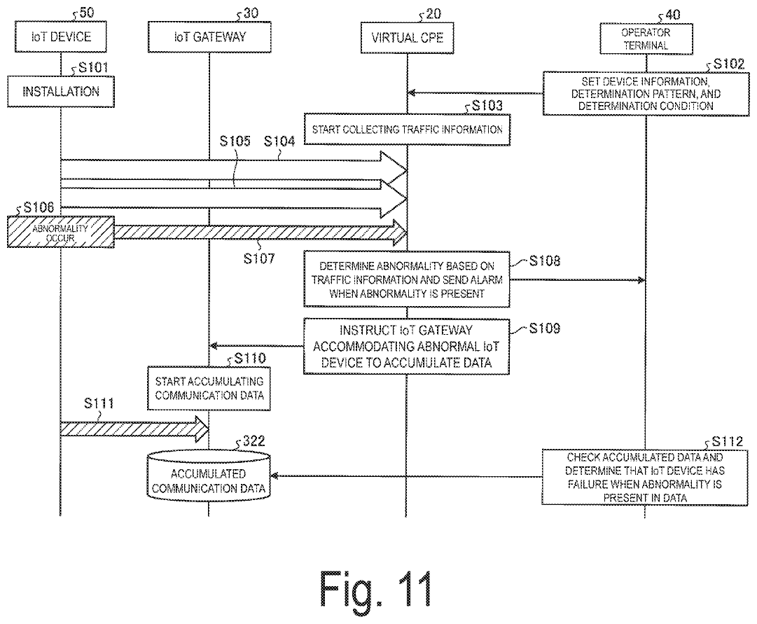

Using FIG. 11, a processing sequence of the determination system 1 will be described. FIG. 11 is a sequence diagram illustrating the processing sequence of the determination system according to the first embodiment. As illustrated in FIG. 11, when the IoT device 50 is installed (Step S101), the operator terminal 40 sets the device information, the determination pattern, and the determination condition to the virtual CPE 20 according to an operator's operation (Step S102).

The virtual CPE 20 starts collecting traffic information (Step S103). The IoT device 50 transmits data to the cloud server 10 via the virtual CPE 20 (S104, S105). At this time, the virtual CPE 20 determines whether the collected traffic information matches the determination condition.

When an abnormality occurs in the IoT device 50 (Step S106) and an abnormality occurs in the traffic (Step S107), the virtual CPE 20 determines the abnormality based on traffic information, and when there is an abnormality (Step S108), transmits an alarm to the operator terminal 40 (Step S108).

The virtual CPE 20 further instructs the IoT gateway 30 accommodating the abnormal IoT device 50 to accumulate data transmitted from the IoT device 50 (Step S109). Then, the IoT gateway 30 starts accumulating data (Step S110).

Thereafter, the IoT device 50 continues to transmit data in the state where the abnormality has occurred (Step S111). However, the transmitted data is accumulated as the accumulated communication data 322. Then, the operator can confirm the accumulated data via the operator terminal 40, and determine that the IoT device 50 has a failure when there is an abnormality in the data (Step S112).

### Effect of First Embodiment

The collection unit 22 collects traffic information generated when data is transmitted from the IoT device 50 connected to the network. When the traffic information collected by the collection unit 22 satisfies the determination condition preset based on the traffic pattern of each IoT device 50, the determination unit 23 determines that an abnormality occurs in the IoT device 50 that generates the traffic. In this manner, the virtual CPE 20 makes a determination using the determination condition based on the traffic pattern of each IoT device 50 and thus, does not need to prepare a command for each IoT device 50. The virtual CPE 20 can also use information regarding traffic generated in normal operation of the IoT device 50 to make a determination. Thus, according to the present embodiment, it is possible to easily determine a failure of the IoT device at low costs.

When the determination unit 23 determines that an abnormality occurs in the IoT device 50, the instruction unit 24 instructs the IoT gateway 30 accommodating the IoT device 50 to accumulate data to be transmitted from the IoT device 50. As a result, according to the present embodiment, communication data generated by the IoT device 50 after the IoT device 50 determined to be abnormal is not lost. Note that the accumulated data may be transmitted to the cloud server 10 and merged after the abnormality is removed or after it is found that there is no abnormality.

When the traffic information collected by the collection unit 22 satisfies the determination condition that is the combination of the determination pattern identified for each traffic pattern of each IoT device 50 and the traffic amount expected for each IoT device 50. the determination unit 23 determines that an abnormality occurs in the IoT device 50 that generates the traffic. Thus, in the present embodiment, the determination conditions can be patterned. Therefore, the operator can easily create the determination condition by simply setting the specific numerical value to the determination pattern.

### System Configuration and the Like

Further, each illustrated component of each apparatus is functional and does not necessarily need to be physically configured as illustrated in the drawing. That is, a specific form of distribution and integration of the respective apparatuses is not limited to a form illustrated in the drawings, and all or some of the apparatuses can be distributed or integrated functionally or physically in any units according to various loads, and use situations. Further, all or any part of each processing function to be performed in each apparatus can be implemented by the CPU and a program being analyzed and executed by the CPU, or can be implemented as hardware by wired logic.

In addition, all or some of the processes described as being performed automatically among the processes described in the present embodiment can be performed manually, or all or some of the processes described as being performed manually can be performed automatically by a known method. The processing procedures, the control procedures, the specific names, and information including various data and parameters described in the specification or illustrated in the drawings may be freely changed except for specified cases.

### Program

As an embodiment, the virtual CPE 20 or the IoT gateway 30 can be implemented by installing a determination program for executing the determination processing described above on a desired computer as packaged software or on-line software. For example, by causing an information processing apparatus to execute the determination program described above, the information processing apparatus can be configured to function as the virtual CPE 20. Here, the information processing apparatus includes a desktop or laptop personal computer. In addition, as the information processing apparatus, a mobile communication terminal such as a smart phone, a mobile phone, and a Personal Handyphone System (PHS), or a slate terminal such as Personal Digital Assistant (PDA) are included in the category.

In addition, the virtual CPE 20 can be implemented as a determination server apparatus that has a terminal apparatus used by a user as a client and provides services regarding the determination processing described above to the client. For example, the determination server apparatus is implemented as a server apparatus that provides a determination service in which traffic information is input and a determination result is output. In this case, the determination server apparatus may be implemented as a web server or may be implemented as a cloud that provides services regarding the determination processing through outsourcing.

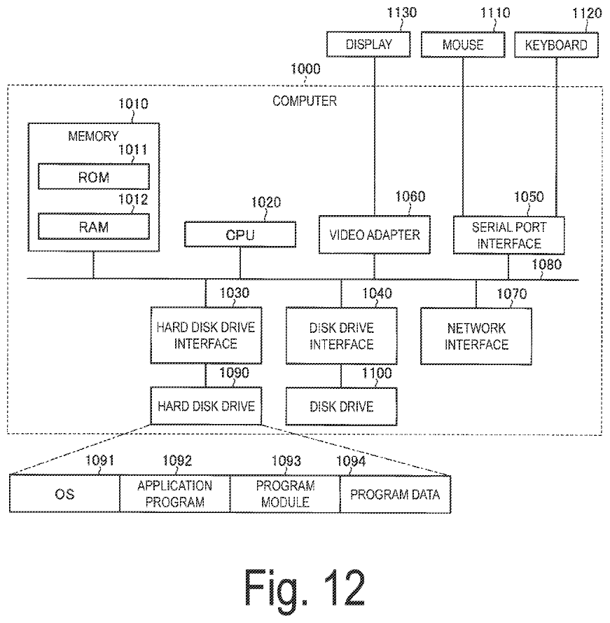

FIG. 12 is a diagram illustrating one example of a computer that executes the determination program. The computer 1000 has, for example, a memory 1010 and a CPU 1020. The computer 1000 has a hard disk drive interface 1030, a disk drive interface 1040, a serial port interface 1050, a video adapter 1060, and a network interface 1070. These components are connected by a bus 1080.

The memory 1010 includes a Read Only Memory (ROM) 1011 and a RAM 1012. The ROM 1011 stores, for example, a boot program such as a Basic Input Output System (BIOS). The hard disk drive interface 1030 is connected to a hard disk drive 1090. The disk drive interface 1040 is connected to a disk drive 1100. For example, a removable storage medium such as a magnetic disk or an optical disc is inserted into the disk drive 1100. The serial port interface 1050 is connected, for example, to a mouse 1110 and a keyboard 1120. The video adapter 1060 is connected, for example, to a display 1130.

Here, the hard disk drive 1090 stores, for example, an OS 1091, an application program 1092, a program module 1093, and program data 1094. That is, a program defining each processing of the virtual CPE 20 is implemented as the program module 1093 in which computer-executable code is described. The program module 1093 is stored, for example, in the hard disk drive 1090. For example, the program module 1093 for executing the same processing as the functional configuration of the virtual CPE 20 is stored in the hard disk drive 1090. Note that the hard disk drive 1090 may be replaced by an SSD.

Setting data used in the processing of the embodiments described above is stored as the program data 1094, for example, in the memory 1010 or the hard disk drive 1090. The CPU 1020 reads the program module 1093 and the program data 1094 stored in the memory 1010 or the hard disk drive 1090 into the RAM 1012 as necessary, and executes the processing of the above-described embodiments.

The program module 1093 and the program data 1094 are not limited to being stored in the hard disk drive 1090. For example, the program module 1093 and the program data 1094 may be stored in a removable storage medium and read by the CPU 1020 via the disk drive 1100 or the like. Alternatively, the program module 1093 and the program data 1094 may be stored in other computers connected via a network (a Local Area Network (LAN), and a Wide Area Network (WAN)). Then, the program module 1093 and the program data 1094 may be read from the other computer by the CPU 1020 via the network interface 1070.

### REFERENCE SIGNS LIST

1 Determination system
2 Carrier network
3 Cloud network
10 Cloud server
20 Virtual CPE
21 Management unit
22 Collection unit
23 Determination unit
24 Instruction unit
25 Input/output unit
30 IoT gateway
31 Instruction management unit
32 Accumulation unit
33 Input/output unit
40 Operator terminal
50 IoT device
211 Device information transmission and reception unit
212 Device information
213 Device determination information
221 Traffic information collection unit
222 Traffic information calculation unit
223 Traffic information
231 Determination information transmission and reception unit
232 Determination processing implementation unit
233 Determination processing information
241 Instruction transmission and reception unit
242 Instruction implementation unit
243 CPE instruction information
311 CPE instruction transmission and reception unit
312 CPE instruction processing unit
313 CPE information
314 CPE state
321 Communication data transmission and reception unit
322 Accumulated communication data

1. A determination apparatus comprising:
a collection unit configured to collect information of traffic generated when based on data being transmitted from a device connected to a network; and
a determination unit configured to determine that an abnormality occurs in the device that generated the traffic based on the information of the traffic collected by the collection unit satisfying a determination condition preset based on a traffic pattern of each of a plurality of the devices.

2. The determination apparatus according to claim 1, further comprising an instruction unit configured to, based on the determination unit determining that the abnormality occurs in the device, instruct a gateway that accommodates the device to accumulate the data transmitted from the device.

3. The determination apparatus according to claim 1, wherein
the determination unit is configured to determine that the abnormality occurs in the device that generated the traffic based on the information of the traffic collected by the collection unit satisfying a determination condition that is a combination of a determination pattern identified for the traffic pattern of each of the plurality of the devices and a traffic amount expected for each of the plurality of the devices.

4. A gateway that accommodates a device, the gateway comprising:
an accumulation unit configured to, in response to an instruction from a determination apparatus determining that an abnormality occurs in the device based on information of traffic generated when data is transmitted from the device, stop transferring the data transmitted from the device to the determination apparatus, and to accumulate the data.

5. A determination method comprising:
collecting information of traffic generated when data is transmitted from a device connected to a network; and
determining that an abnormality occurs in the device that generated the traffic based on the information of the traffic collected satisfying a determination condition preset based on a traffic pattern of each of a plurality of the devices.

6. (canceled)
